(19) United States
(12) Patent Application Publication
(10) Pub. No.: US 2020/0174209 A1
(43) Pub. Date: Jun. 4, 2020

(54) COMPACT INDOOR OPTICAL FIBER BACKBONE CABLE UTILIZING ROLLABLE RIBBON

(71) Applicant: OFS Fitel, LLC, Norcross, GA (US)

(72) Inventors: Peter A. Weimann, Atlanta, GA (US); Henson P. Toland, Atlanta, GA (US)

(73) Assignee: OFS Fitel, LLC, Norcross, GA (US)

(21) Appl. No.: 16/367,809

(22) Filed: Mar. 28, 2019

Related U.S. Application Data
(60) Provisional application No. 62/774,461, filed on Dec. 3, 2018.

(51) Int. Cl. G02B 6/44

(52) U.S. Cl. CPC G02B 6/4432

(57) ABSTRACT

An indoor optical fiber backbone cable may include a cable jacket, at least one ribbon bundle having two or more partially bonded optical fiber ribbons contained within the cable jacket, and two or more reinforcing yarns. The cable jacket may have an outside diameter not greater than 8.0 mm. The optical fiber ribbons may be contained at a packing density in a range from 1.0 to 5.0 fibers/mm² with respect to the outside diameter of the cable jacket. The optical fiber cable may be devoid of tensile reinforcement members other than the reinforcing yarns.

### CROSS-REFERENCE TO RELATED APPLICATION

The benefit of and priority to U.S. Provisional Patent Application No. 62/774,461, filed Dec. 3, 2018, entitled “COMPACT INDOOR BACKBONE CABLES UTILIZING ROLLABLE RIBBON,” is hereby claimed, and the contents thereof incorporated herein by this reference in their entirety as if fully set forth below and for all applicable purposes.

### BACKGROUND

An optical fiber cable comprises one or more optical fibers enclosed within a jacket. An indoor optical fiber backbone cable is a type of optical fiber cable that is used to distribute optical signals from one section of a building to another. Indoor optical fiber backbone cables commonly have characteristics conducive to long horizontal runs in overhead ladder racks, underfloor trays, vertical risers, and other building features associated with service provider central office and data center facilities. Such characteristics include high tensile strength to withstand the pull tension of the installation process, and high stiffness to provide crush and kink resistance and to protect the relatively fragile glass optical fibers. A traditional type of indoor backbone cable uses tight-buffered optical fibers, in which each fiber is encased in a relatively thick layer of polymeric material for crush and kink resistance. Common diameters for tight-buffered fibers are 900 microns and 600 microns. However, use of such tight buffered fiber often results in a bulky, large cable.

Smaller compact backbone cables can be achieved by using unbuffered optical fibers, which commonly have diameters of 250 microns or 200 microns. In indoor backbone cables, 250 micron or 200 micron optical fibers may be contained in a core tube centered within the jacket or one or more sub-jackets or buffer tubes within the jacket. Core tubes and buffer tubes are, like the cable jacket, commonly made of a relatively stiff, hard material to help protect the fibers. To provide high tensile strength, an optical fiber backbone cable may include one or more rigid reinforcing members, such as a fiberglass-epoxy or aramid-epoxy composite rods or solid steel wires. Some cables may include a layer of aramid or fiberglass reinforcing yarn between the fibers and the jacket to provide tensile strength.

The unbuffered fibers in a compact backbone cable are commonly organized into subunits by grouping them within sub jackets or buffer tubes or by loosely wrapping groups of fibers in threads or yarns for ease of identification. Although subunits of various numbers of fibers are known, subunits of 12 fibers are particularly common because fiber optic networks are commonly organized in circuits of 12.

Flexibility and compact size (i.e., diameter) are desirable characteristics for indoor backbone cables. Providing a compact cable with a fiber count in the range common for indoor backbone cables implies a high packing density.

The term optical fiber “ribbon” refers to two or more parallel optical fibers that are joined together along their lengths. A material commonly referred to as a matrix adheres the fibers together. In a “flat” (also referred to as “encapsulated”) type of optical fiber ribbon, the fibers may be fully encapsulated within the matrix material. The rigidity and high aspect ratio of encapsulated optical fiber ribbons presents challenges to achieving high fiber packing density in cables, as the ribbons are generally formed into rectangular stacks that must be contained in a substantially round cable structure. So-called “rollable” or “partially bonded” optical fiber ribbons have been developed to achieve high fiber packing density in cables. In a rollable ribbon, the matrix material is intermittently distributed along the fibers, providing sufficient flexibility to roll up each individual ribbon about an axis parallel to the fibers or otherwise compact the ribbon into a fiber bundle with a roughly cylindrical shape.

Providing flexible, compact, high packing density indoor optical fiber backbone cables presents challenges, which may be addressed by the present invention in the manner described below.

### SUMMARY

The present invention relates generally to indoor optical fiber backbone cables. In an exemplary embodiment, an optical fiber cable may include a cable jacket, at least one ribbon bundle comprising a plurality of partially bonded optical fiber ribbons, and a plurality of reinforcing yarns. The cable jacket may have an outside diameter not greater than 8.0 millimeters (mm). The optical fiber ribbons may be contained at a packing density in a range from 1.0 to 5.0 fibers/mm² with respect to the outside diameter of the cable jacket. The optical fiber cable may be devoid of tensile reinforcement members other than the reinforcing yarns.

Other cables, methods, features, and advantages will be or become apparent to one of skill in the art upon examination of the following figures and detailed description. It is intended that all such additional systems, methods, features, and advantages be included within this description, be within the scope of the specification, and be protected by the accompanying claims.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is cross-sectional view of a first example of an optical fiber backbone cable, in accordance with exemplary embodiments of the invention.

FIG. 2 is cross-sectional view of a second example of an optical fiber backbone cable, in accordance with exemplary embodiments of the invention.

FIG. 3 is cross-sectional view of a third example of an optical fiber backbone cable, in accordance with exemplary embodiments of the invention.

FIG. 4 is cross-sectional view of a fourth example of an optical fiber backbone cable, in accordance with exemplary embodiments of the invention.

FIG. 5 is a top plan view of a portion of rollable or partially bonded optical fiber ribbon.

### DETAILED DESCRIPTION

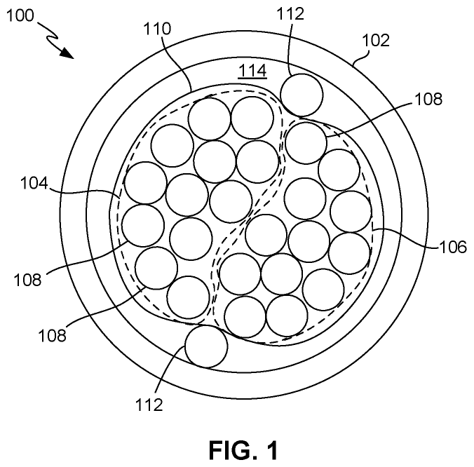

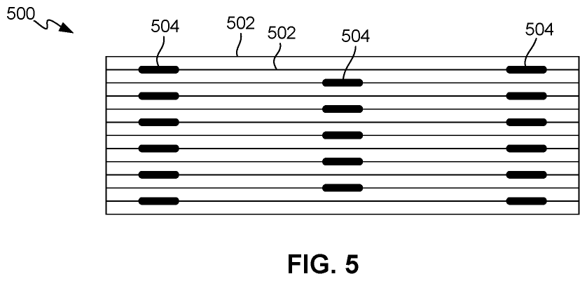

As illustrated in FIG. 1 (schematically, and not to scale), in an illustrative or exemplary embodiment of the invention, an optical fiber cable 100 includes a cable jacket 102, a first rollable or partially bonded ribbon 104, and a second rollable or partially bonded ribbon 106. Cable jacket 102 may be made of a flame-retardant material to comply with standardized fire safety requirements for indoor cables. Each of ribbons 104 and 106 comprises optical fibers 108, as described below in further detail with regard to FIG. 5. In FIG. 1, a conceptual boundary or extent of each of ribbons 104 and 106 is indicated in broken line for illustrative purposes. It should be understood that each of ribbons 104 and 106 may assume any cross-sectional shape within cable jacket 102, and the shapes of the broken lines are intended only to be illustrative or exemplary. Although in the embodiment illustrated in FIG. 1 each ribbon 104 and 106 has exactly 12 optical fibers 108, in other embodiments each such ribbon may have any number of such fibers. Accordingly, in the exemplary embodiment illustrated in FIG. 1 optical fiber cable 100 has a total of exactly 24 optical fibers 108. Nevertheless, in other embodiments an optical fiber cable in accordance with the present disclosure may have a total of up to 144 fibers. Optical fibers 108 may have a standard size, such as an overall diameter of 250 μm.

A binding yarn 110 may be twisted (e.g., helically with respect to the length or extent of optical fiber cable 100) around both ribbons 104 and 106, thereby defining a bundle. In the embodiment illustrated in FIG. 1, optical fiber cable 100 consists of exactly one such bundle consisting of exactly two ribbons 104 and 106. Nevertheless, in other embodiments such a cable may include any number of bundles, each having two or more ribbons. As the function of binding yarn 110 in the embodiment illustrated in FIG. 1 is only to bundle or bind ribbons 104 and 106 together, binding yarn 110 is only required to have enough tensile strength to survive the manufacturing process. Polyester filament or spun polyester thread are examples of materials that are suitable for use as binding yarn. Binding yarn 110 may be color-coded for identification and may also be coated with a water-swellable (e.g., super-absorbent polymer) material.

Two or more reinforcing yarns 112 may be included in optical fiber cable 100 to provide tensile strength. Accordingly, in an exemplary embodiment, reinforcing yarns 112 may be made of a high tensile strength material such as para-aramid (e.g., Kevlar®). Reinforcing yarns 112 may have a tensile modulus of, for example, 80,000 megapascal (MPa) or more. Other high-strength yarns, such as fiberglass or liquid-crystal polymers (e.g., Vectran™) may also be suitable. Note that the tensile modulus of reinforcing yarns 112 is one or more orders of magnitude greater than the (thus comparatively insignificant) tensile modulus of binding yarns 110. Reinforcing yarns 112 may provide a tensile rating of, for example, 660 N or more for optical fiber cable 100. Accordingly, reinforcing yarns 112 provide essentially all of the tensile strength required for optical fiber cable 100 to meet installation load standards. Reinforcing yarns 112 may be coated with a water-swellable material.

In the embodiment illustrated in FIG. 1, ribbons 104 and 106, binding yarn 110, and reinforcing yarns 112 are all contained within the interior 114 of cable jacket 102, and no other elements (e.g., rods, tubes, sub-jackets, etc.) are contained within cable jacket 102. Cable jacket 102 is made from a flame-retardant material to comply with fire safety requirements for indoor cables. Cable jacket 102 may be colored for purposes of cable identification, and may also contain stabilizers that limit degradation caused by ultraviolet radiation. Cable jacket 102 may have an outside diameter of no more than 8.0 mm. Optical fibers 108 may be contained at a packing density of between 1.0 and 5.0 fibers/mm² with respect to cable jacket 102. For purposes of this disclosure, packing density is defined as the number of fibers divided by the cable jacket outside diameter. The absence of strength-providing rods, tubes, sub-jackets, etc., in optical fiber cable 100 helps provide such a relatively high packing density as well as high flexibility.

Note that no rigid reinforcement with high compressive stiffness, such as a fiberglass-epoxy composite rod, solid steel wire, braided steel wires, or other strength member with a high compressive stiffness, is included in optical fiber cable 100. The reinforcing yarns 112 have a high tensile modulus, but negligible compressive stiffness. Optical fiber cable 100 and other cable examples described below are configured to be as small as possible, as flexible as possible, and suitable for use in compact indoor spaces. Placing a rigid reinforcement in the center would make the cables stiffer and harder to bend, requiring a larger cable bend radius and making the cables harder to handle in a congested indoor environment. Instead, tensile stiffness is supplied through deployment of reinforcing yarns 112.

In the embodiment illustrated in FIG. 1, optical fiber cable 100 does not include any reinforcing yarns other than reinforcing yarns 112, such as, for example, reinforcing yarns twisted around the bundle of ribbons 104 and 106. In the embodiment illustrated in FIG. 1, cable 100 consists of exactly one bundle consisting of exactly two ribbons 104 and 106. Nevertheless, in related embodiments such a cable may have any number of one or more bundles, each consisting of two or more ribbons bundled together by binding yarns (and not bundled together by reinforcing yarns).

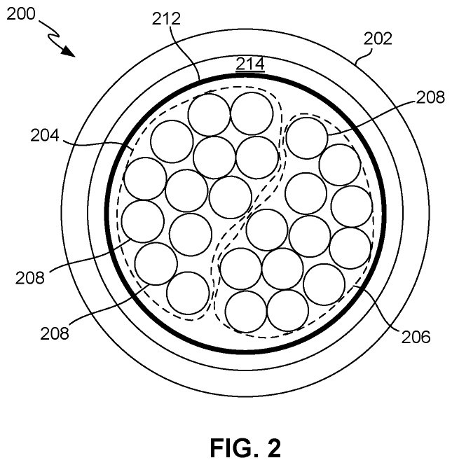

As illustrated in FIG. 2 (schematically, and not to scale), in an illustrative or exemplary embodiment of the invention, an optical fiber cable 200 includes a cable jacket 202, a first rollable or partially bonded ribbon 204, and a second rollable or partially bonded ribbon 206. Cable jacket 202 is made of a flame-retardant material to comply with standardized fire safety requirements for indoor cables. Cable jacket 202 may be colored for purposes of cable identification and may also contain stabilizers that limit degradation caused by ultraviolet radiation. Each of ribbons 204 and 206 comprises optical fibers 208, as described below in further detail with regard to FIG. 5. As in the other figures, in FIG. 2 a conceptual boundary or extent of each of ribbons 204 and 206 is indicated in broken line for illustrative purposes. Although in the embodiment illustrated in FIG. 2 each ribbon 204 and 206 has exactly 12 optical fibers 208, in other embodiments each such ribbon may have any number of such fibers. Accordingly, in the exemplary embodiment illustrated in FIG. 2 optical fiber cable 200 has a total of exactly 24 optical fibers 208. Optical fibers 208 may have a standard size, such as an overall diameter of 250 μm.

Two or more reinforcing yarns 212 may be twisted (e.g., helically) around ribbons 204 and 206 to provide tensile strength. Accordingly, reinforcing yarns 212 may be made of a high tensile strength material such as para-aramid (e.g., Kevlar®). Reinforcing yarns 212 may have a tensile modulus of, for example, 80,000 MPa or more. Reinforcing yarns 212 may provide a tensile rating of, for example, 440 N or more for optical fiber cable 200. Note that no rigid reinforcement, such as a fiberglass-epoxy composite rod, solid steel wire, braided steel wires, or other high tensile modulus strength member, is included in optical fiber cable 200. Instead, reinforcing yarns 212 provide essentially all of the tensile strength required for optical fiber cable 200 to meet installation load standards. Reinforcing yarns 212 may be coated with a water-swellable material.

In the embodiment illustrated in FIG. 2, ribbons 204 and 206 and reinforcing yarns 212 are all contained within the interior 214 of cable jacket 202, and no other elements (e.g., rods, tubes, sub-jackets, etc.) are contained within cable jacket 202. Cable jacket 202 may have an outside diameter of no more than 8.0 mm. Optical fibers 208 may be contained at a packing density of between 1.0 and 5.0 fibers/mm² with respect to cable jacket 202. The absence of strength-providing rods, tubes, sub-jackets, etc., in optical fiber cable 200 helps provide such a relatively high packing density as well as high flexibility.

In the embodiment illustrated in FIG. 2, optical fiber cable 200 does not include any binding yarns. Rather, reinforcing yarns 212 also serve to bind ribbons 204 and 206 together to define a bundle. In the embodiment illustrated in FIG. 2, cable 200 consists of exactly one such bundle consisting of exactly two ribbons 204 and 206. Nevertheless, in related embodiments such a cable may have any number of one or more bundles, each consisting of two or more ribbons bundled together by reinforcing yarns (and without binding yarns).

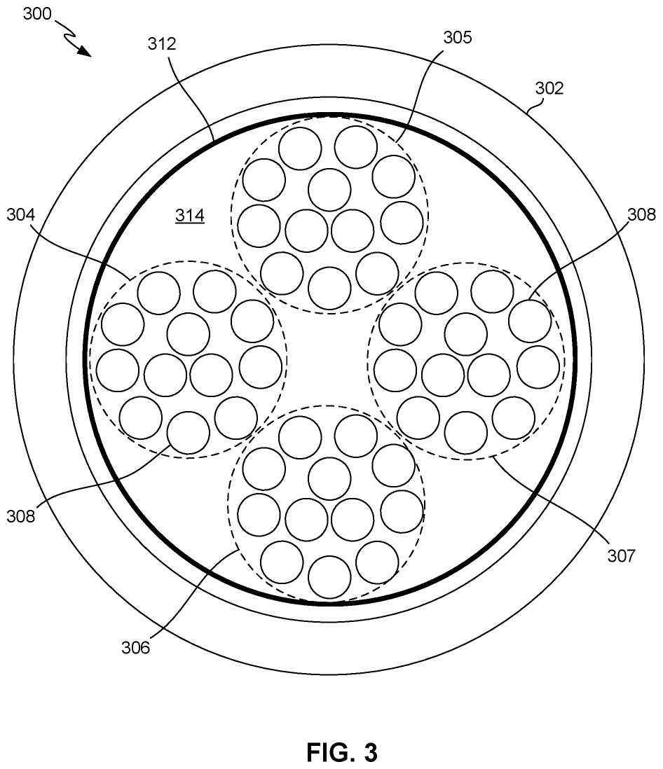

As illustrated in FIG. 3 (schematically, and not to scale), in an illustrative or exemplary embodiment of the invention, an optical fiber cable 300 includes a cable jacket 302, a first rollable or partially bonded ribbon 304, a second rollable or partially bonded ribbon 305, a third rollable or partially bonded ribbon 306, and a fourth rollable or partially bonded ribbon 307. Cable jacket 302 is made of a flame-retardant material to comply with standardized fire safety requirements for indoor cables. Cable jacket 302 may be colored for purposes of cable identification, and may also contain stabilizers that limit degradation caused by ultraviolet radiation. Each of ribbons 304-307 comprises optical fibers 308, as described below in further detail with regard to FIG. 5. Although in the embodiment illustrated in FIG. 3 each of ribbons 304-307 has exactly 12 optical fibers 308, in other embodiments each such ribbon may have any number of such fibers. Accordingly, in the exemplary embodiment illustrated in FIG. 3 optical fiber cable 300 has a total of exactly 48 optical fibers 308. Optical fibers 308 may have a standard size, such as an overall diameter of 250 μm.

Two or more reinforcing yarns 312 may be twisted (e.g., helically) around ribbons 304-307 to provide tensile strength. Accordingly, reinforcing yarns 312 may be made of a high tensile strength material such as para-aramid (e.g., Kevlar®). Reinforcing yarns 312 may have a tensile modulus of, for example, 80,000 MPa or more. Reinforcing yarns 312 may provide a tensile rating of, for example, 660 N or more for optical fiber cable 300. Note that no rigid reinforcement, such as a fiberglass-epoxy composite rod, solid steel wire, braided steel wires, or other high tensile modulus strength member, is included in optical fiber cable 300. Instead, reinforcing yarns 312 provide essentially all of the tensile strength required for optical fiber cable 300 to meet installation load standards. Reinforcing yarns 312 may be coated with a water-swellable material.

In the embodiment illustrated in FIG. 3, ribbons 304-307 and reinforcing yarns 312 are all contained within the interior 314 of cable jacket 302, and no other elements are contained within cable jacket 302. Cable jacket 302 may have an outside diameter of no more than 8.0 mm. Optical fibers 308 may be contained at a packing density of between 1.0 and 5.0 fibers/mm² with respect to cable jacket 302. The absence of strength-providing rods, tubes, sub-jackets, etc., in optical fiber cable 300 helps provide such a relatively high packing density as well as high flexibility.

In the embodiment illustrated in FIG. 3, optical fiber cable 300 does not include any binding yarns. Rather, reinforcing yarns 312 also serve to bind ribbons 304-307 together to define a bundle. In the embodiment illustrated in FIG. 3, cable 300 consists of exactly one such bundle consisting of exactly four ribbons 304-307. Nevertheless, in related embodiments such a cable may have any number of one or more bundles, each consisting of two or more ribbons bundled together by reinforcing yarns (and without binding yarns).

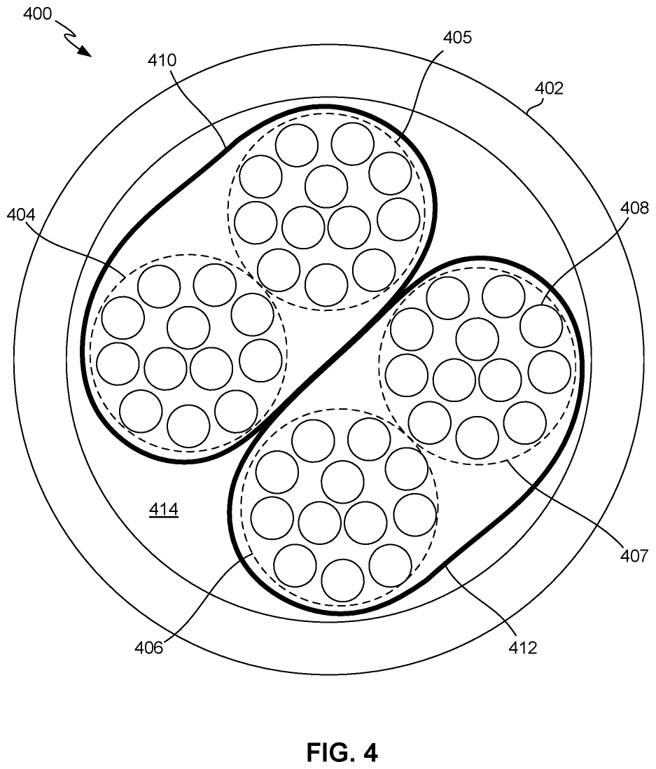

As illustrated in FIG. 4 (schematically, and not to scale), in an illustrative or exemplary embodiment of the invention, an optical fiber cable 400 includes a cable jacket 402, a first rollable or partially bonded ribbon 404, a second rollable or partially bonded ribbon 405, a third rollable or partially bonded ribbon 406, and a fourth rollable or partially bonded ribbon 407. Cable jacket 402 is made of a flame-retardant material to comply with standardized fire safety requirements for indoor cables. Cable jacket 402 may be colored for purposes of cable identification, and may also contain stabilizers that limit degradation caused by ultraviolet radiation. Each of ribbons 404-407 comprises optical fibers 408, as described below in further detail with regard to FIG. 5 Although in the embodiment illustrated in FIG. 4 each of ribbons 404-407 has exactly 12 optical fibers 408, in other embodiments each such ribbon may have any number of such fibers. Accordingly, in the exemplary embodiment illustrated in FIG. 4 optical fiber cable 400 has a total of exactly 48 optical fibers 408. Optical fibers 408 may have a standard size, such as an overall diameter of 250 μm.

Two or more reinforcing yarns 410 may be twisted (e.g., helically) around ribbons 404 and 405 to define a first bundle. Likewise, two or more reinforcing yarns 412 may be twisted (e.g., helically) around ribbons 406 and 407 to define a second bundle. Reinforcing yarns 410 and 412 provide tensile strength to optical fiber cable 400. Accordingly, reinforcing yarns 410 and 412 may be made of a high tensile strength material such as para-aramid (e.g., Kevlar®). Reinforcing yarns 410 and 412 may have a tensile modulus of, for example, 80,000 MPa or more. Reinforcing yarns 410 and 412 may provide a tensile rating of, for example, 660 N or more for optical fiber cable 400. Note that no rigid reinforcement, such as a fiberglass-epoxy composite rod, solid steel wire, braided steel wires, or other high tensile modulus strength member, is included in optical fiber cable 400. Instead, reinforcing yarns 410 and 412 provide essentially all of the tensile strength required for optical fiber cable 400 to meet installation load standards. Reinforcing yarns 410 and 412 may be coated with a water-swellable material.

Although for purposes of clarity, each bundle (i.e., the first bundle consisting of ribbons 404 and 405 bundled together by reinforcing yarns 410, and the second bundle consisting of ribbons 406 and 407 bundled together by reinforcing yarns 412) is depicted in FIG. 4 as having a generally oval cross-sectional shape, it should be understood that each bundle may assume any cross-sectional shape within cable jacket 402. For example, the shape of each bundle may be more circular than oval, depending on how tightly reinforcing yarns 410 and 412 are applied.

In the embodiment illustrated in FIG. 4, ribbons 404-407 and reinforcing yarns 410 and 412 are all contained within the interior 414 of cable jacket 402, and no other elements (e.g., rods, tubes, sub-jackets, etc.) are contained within cable jacket 402. Cable jacket 402 may have an outside diameter of no more than 8.0 mm. Optical fibers 408 may be contained at a packing density of between 1.0 and 5.0 fibers/mm² with respect to cable jacket 402. The absence of strength-providing rods, tubes, sub-jackets, etc., in optical fiber cable 400 helps provide such a relatively high packing density as well as high flexibility.

In the embodiment illustrated in FIG. 4, optical fiber cable 300 does not include any binding yarns. Rather, reinforcing yarns 410 also serve to bind ribbons 404-405 into a first bundle, and reinforcing yarns 412 also serve to bind ribbons 406-407 into a second bundle. In the embodiment illustrated in FIG. 4, cable 400 consists of exactly two such bundles, each consisting of exactly two ribbons 404-407. Nevertheless, in related embodiments such a cable may have any number of two or more bundles, each consisting of two or more ribbons bundled together by reinforcing yarns (and without binding yarns).

A rollable (also referred to as partially bonded) optical fiber ribbon 500 is shown in FIG. 5. Rollable optical fiber ribbon 500 may be an example of any of ribbons 104-106 (FIG. 1), 204-206 (FIG. 2), 304-307 (FIG. 3), or 404-407 (FIG. 4). Rollable optical fiber ribbon 500 comprises two or more optical fibers 502 joined to each other intermittently along their lengths with patches of adhesive, commonly referred to as a matrix material 504. The pattern of matrix material 504 shown in FIG. 5 or other characteristics of rollable optical fiber ribbon 500 described herein are intended only as examples, and one of ordinary skill in the art will recognize that other types of rollable optical fiber ribbon are suitable.

As well understood by one of ordinary skill in the art, while rollable optical fiber ribbon 500 has the ribbon shape shown in FIG. 5 when laid flat with its optical fibers 502 arrayed parallel to each other, optical fibers 502 can also roll into or otherwise assume a compact bundle or roughly cylindrical shape. That is, the intermittent rather than continuous distribution of matrix material 504 provides rollable optical fiber ribbon 500 with sufficient flexibility to be rolled about an axis substantially parallel to the fibers. The terms “rollable” and “partially bonded” are understood by one of ordinary skill in the art in the context of optical fiber ribbons to specifically refer to a ribbon having this characteristic, provided by the intermittent rather than continuous distribution of matrix material 504. A “rollable” ribbon may be contrasted with what is commonly referred to in the art as a “flat” or “encapsulated” ribbon, in which matrix material is distributed continuously along the length of the fibers. In a flat ribbon, the fibers may be fully encapsulated within the matrix material. The rigidity of encapsulated optical fiber ribbons presents challenges to achieving high fiber packing density in cables. The development of rollable ribbons has led to higher fiber packing density in cables.

An optical fiber cable in accordance with the present disclosure, including the exemplary embodiments described above, may be more economical, more compact, and more flexible than prior indoor backbone cables having similar fiber counts. Nevertheless, such embodiments are intended to be illustrative or exemplary rather than limiting. It is to be understood that the invention is defined by the appended claims and is not limited to the specific embodiments described.

What is claimed is:

1. An optical fiber cable, comprising:
a cable jacket having an outside diameter not greater than 8.0 millimeters (mm);
at least one ribbon bundle comprising a plurality of partially bonded optical fiber ribbons contained within the cable jacket at a packing density in a range from 1.0 to 5.0 fibers/mm² with respect to the outside diameter of the cable jacket; and
a plurality of reinforcing yarns within the cable jacket, the optical fiber cable devoid of tensile reinforcement other than the reinforcing yarns.

2. The optical fiber cable of claim 1, wherein the optical fiber cable contains no more than 144 optical fibers.

3. The optical fiber cable of claim 1, wherein one or more of the reinforcing yarns are twisted around the ribbon bundle.

4. The optical fiber cable of claim 1, wherein one or more of the reinforcing yarns is coated with a water-swellable material.

5. The optical fiber cable of claim 1, further comprising a binding yarn twisted around the ribbon bundle, wherein none of the reinforcing yarns are twisted around the ribbon bundle.

6. The optical fiber cable of claim 5, wherein the binding yarn is coated with a water-swellable material.

7. The optical fiber cable of claim 1, wherein the at least one ribbon bundle comprises a plurality of ribbon bundles, and one or more of the reinforcing yarns are twisted around each ribbon bundle.

8. The optical fiber cable of claim 1, further comprising a plurality of binding yarns, wherein the at least one ribbon bundle comprises a plurality of ribbon bundles, a binding yarn is twisted around each ribbon bundle, and none of the reinforcing yarns are twisted around any of the ribbon bundles.

9. The optical fiber cable of claim 1, wherein the plurality of reinforcing yarns comprise aramid.

10. An optical fiber cable, comprising:
a cable jacket having an outside diameter not greater than 8.0 millimeters (mm);
a plurality of ribbon bundles, each ribbon bundle comprising a plurality of partially bonded optical fiber ribbons, the plurality of ribbon bundles contained within the cable jacket at a packing density in a range from 1.0 to 5.0 fibers/mm² with respect to the outside diameter of the cable jacket; and
a plurality of reinforcing yarns within the cable jacket, one or more of the reinforcing yarns twisted around each of the ribbon bundles, the optical fiber cable devoid of tensile reinforcement other than the reinforcing yarns.

11. The optical fiber cable of claim 10, wherein the optical fiber cable contains no more than 144 optical fibers.

12. The optical fiber cable of claim 10, wherein one or more of the reinforcing yarns is coated with a water-swellable material.

13. The optical fiber cable of claim 10, wherein the plurality of reinforcing yarns comprise aramid.
